(19) United States
(12) Patent Application Publication
(10) Pub. No.: US 2002/0169868 A1
(43) Pub. Date: Nov. 14, 2002

(54) Interactive remote monitoring of client page render times on a per user basis

(76) Inventors: Michael S. Lopke, Boise, ID (US); Ronald K. Rose, Emmett, ID (US)

Correspondence Address: HEWELETT-PACKARD COMPANY, Intellectual Property Administration, P.O. Box 272400, Fort Collins, CO, 80527-2400, US

(21) Appl. No.: 09/839,852

(22) Filed: Apr. 20, 2001

(51) Int. Cl. G06F 15/173; G06F 15/16

(52) U.S. Cl. 709/224; 709/203

(57) ABSTRACT

A server architecture remotely monitors client page render times by approximating the time lapse from when a hyperlink is first activated to request a web page to when the web page is rendered on the requesting client machine. When the server receives a request, it locates or generates the appropriate page and attaches a script with the current time stamp. A session ID is generated to identify the client-server session associated with the time stamp. The stamped page is returned to the client and rendered. The script is executed to return the time stamp to the server. The server measures the time lapse between the returned time stamp and the current time to derive a close approximation of client page render time. To derive the average time-to-render on a per user basis, multiple client page render times that share a common session ID are collected and averaged.

### TECHNICAL FIELD

This invention relates to client-server technologies, and particularly to techniques for monitoring client page render times.

### BACKGROUND

The old adage that “a chain is only as strong as its weakest link” is aptly applicable to web performance in the rapidly evolving networked world. As countless users around the globe have come to realize, a network is only as fast as its slowest connection. Users' experiences with accessing and downloading content over the Internet vary dramatically depending upon whether they are blessed with a fast connection to a website or are forced to tolerate a slow connection. As one might expect, the user who is able to see web pages instantly “pop” up or watch real-time streaming video without disruption will enjoy a much more enriching experience than the user who suffers through a maddening time lapse each time they click a new hyperlink.

Developers of network components are well aware that from a user perspective, the time to display a page is one blatantly noticeable characteristic of web performance and often dictates whether the user experience will be favorable or unfavorable. Ideally, developers would like to quantify a user's experience in terms of how long it takes to render pages requested by the user. Unfortunately, this is more difficult than one might think. There are many factors contributing to the user perception of web performance, including network congestion, the connection speed at which the client is connected to the network, the capabilities of the user's computer, server capabilities and configuration, browser speed, web page design, and so forth. As a result, developing useful metrics for a user's perception of web performance has been somewhat elusive.

Accordingly, there is a need for useful metrics that represent a user's perception of web performance. In particular, there is a need for an accurate and reliable measure of the time that lapses from the moment a user clicks on a hyperlink to the time they actually see the completed web page.

### SUMMARY

This invention concerns techniques for remote monitoring of client page render times, which is a measure of the time from when a hyperlink is first activated to request a web page (or other type of document) to when the web page is rendered on the requesting client machine. Other important events on the client can be measured using the same methods (such as document download times, default script execution times, etc.). During a given client-server session, the page render times are collected and averaged to determine an average page render time on a per user basis.

In the described implementation, client page render times are monitored remotely at the server. When a user actuates a link in a web page, the client submits a request for the page to the server. The server receives the request and locates or generates the appropriate page. A session ID is generated to identify the client-server session associated with the time stamp. The server then attaches a script with a current time stamp and returns the stamped page to the client. The session ID may be sent together with the time stamp when the page is served, or stored at the server. When the client renders the page completely, the script is executed to return the time stamp (and optionally the session ID) to the server.

The server measures the time lapse between the returned time stamp and the current time to derive a close approximation of client page render time. The server assumes that the time required to initially submit a request from the client to the server is approximately the same as the time involved in returning the time stamp from the client to the server. Thus, the measurement approximates the time to render a page after the user clicks the link. The time-to-render values are logged in a log in association with their session ID. An average time-to-render on a per user basis can then be produced as a function of multiple client page render times stored in the log that share a common session ID.

### BRIEF DESCRIPTION OF THE DRAWINGS

FIG. 1 is a block diagram of a client-server system that implements a server-based monitoring system for remote monitoring client page render times on a per user basis.

FIG. 2 is a block diagram of a software architecture implemented on the client-server system to remotely monitor client page render times.

FIG. 3 is a flow diagram of a process for remotely monitoring client page render times on a per user basis.

The same reference numbers are used throughout the figures to reference like components and features.

### DETAILED DESCRIPTION

This invention concerns client-server technologies and particularly relates to methods for monitoring latency from the time a client requests a document from a server (e.g., a web page) to the time the document is rendered for the user. The methods enable derivation of per user statistics to aid a site operator or page developer in better understanding an individual user's experience with a particular network server.

The techniques may be implemented in many different environments, including on public networks (e.g., Internet) and private networks (e.g., corporate intranets). For discussion purposes, the systems and methodologies are described in the context of measuring performance over the Internet, from the time a user activates a hyperlink on a web page to the time the page is actually rendered on the user's computer.

General System

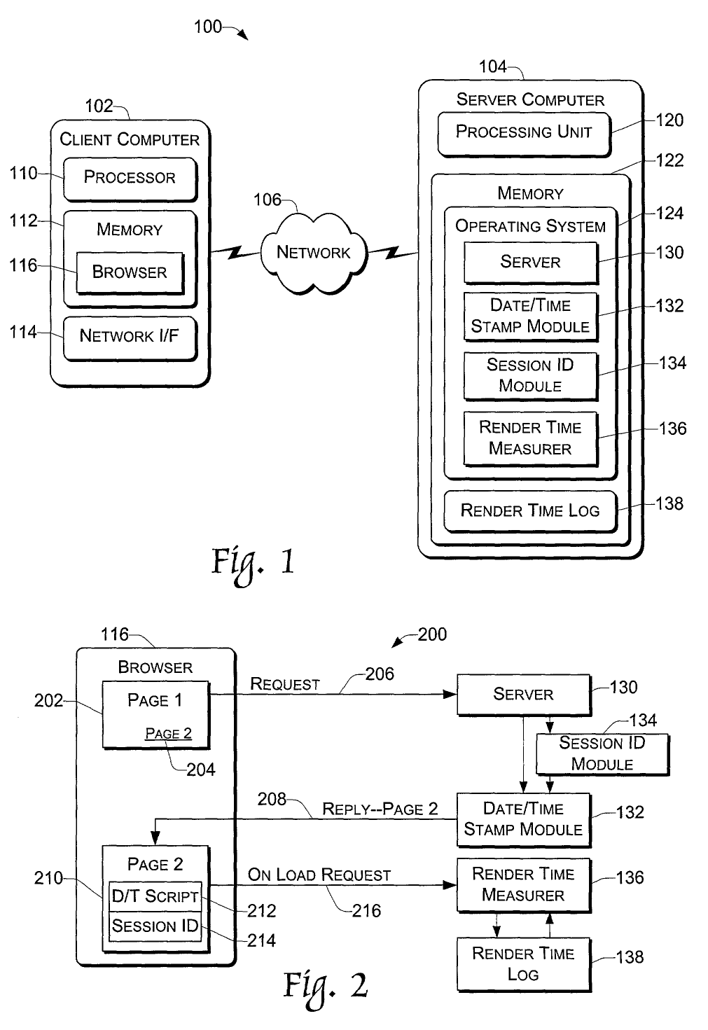

FIG. 1 shows a client-server system 100, which includes a client computer 102 connected to a server computer 104 via a network 106. As is familiar in client-server technologies, the client 102 submits requests for information in the form of data or document(s) over the network to the server 104. The server processes the requests and returns the data or document(s) to the client 102 via the network 106.

The network 106 is representative of many different types of network architectures, including the Internet, an intranet, a local area network (LAN), a wide area network (WAN), or (most likely) a combination of such architectures. The network architectures may be implemented as wire-based technologies (e.g., cable, optical, etc.), wireless technologies (e.g., satellite, cellular, RF, Bluetooth, etc.), or a combination of wire-based and wireless technologies. Moreover, data may be exchanged over the network 106 according to any combination of many diverse communications protocols, including TCP/IP, IPX/SPX, NetBEUI, HTTP (hypertext transport protocol), and so on.

Client computer 102 represents any of a wide range of computing devices, such as a desktop computer, a laptop computer, a handheld or pocket computer, a personal digital assistant (PDA), a cellular phone, an Internet appliance, a consumer electronics device, a gaming console, and so forth. It includes a processor 110, memory 112 (e.g., ROM, RAM, CD-ROM, Flash, disk, etc.), and a network interface 114 (e.g., modem, network card, etc.) to facilitate access to the network 106.

The client computer 102 further includes a browser 116 that is capable of rendering documents written in a markup language, such as HTML (hypertext markup language). The browser is illustrated as being stored in memory 112, but portions of the browser software are executed on processor 110 when the browser is launched. It is noted that although a browser is shown, other software programs that are capable of rendering hypertext documents and facilitating user activation of links may be substituted for the browser.

The browser is implemented with some scripting (e.g. ECMA-Script, JavaScript, or VBScript) or custom code execution ability (e.g. ActiveX controls or dynamic library) and implements a “document rendered” event (or another event of interest, such as document load). An example would be the “onLoad” event supported by web browsers on the BODY tag which “fires” when the document has been rendered. Depending on how this event is implemented in a given client-server environment, the calculation of event time may need to be adjusted (or qualified).

The server computer 104 is representative of many different computers, such as a personal computer that is configured as a data server, a dedicated workstation, a cluster of computers, a minicomputer, a mainframe computer, and so forth. The server 104 includes one or more processing units 120 and memory 122 (e.g., ROM, RAM, Flash, disk, RAID, tape, etc.). An operating system 124 is stored in memory 122 and executes on processing unit 120. Examples of suitable server operating systems include Unix-based operating systems and the Windows NT® operating system from Microsoft Corporation.

The server 104 runs server software 130 to serve data (e.g., HTML documents, video files, audio files, etc.) over the network 106 to the client 102. The server software 130 may be configured to serve static data that preexists on storage or to dynamically generate data in response to the client requests. In implementation, the server 130 is configured as a page server to serve static or dynamic web pages over the Internet in response to HTTP requests.

A date/time stamp module 132 attaches a date/time stamp to the data that is served back to the client 102. The date/time stamp is embedded within a script (e.g., a code sequence written in a scripting language such as JavaScript).

A session ID module 134 generates a session identifier that is unique to the client-server connection session and hence, unique to the user. The unique session ID is generated when the client first connects to the server and is set to expire after some predetermined time period anticipated to be longer than the client-server session. Once generated, the session ID is associated with each time stamp output by the date/time stamp module 132. The session ID may be sent to the client with the date/time stamp when the page or other data is served. Alternatively, the session ID is stored at the server (e.g., in a look up table) and re-associated later with the time stamp when the time stamp is returned to the server.

After the document is returned and rendered at the client, the script is executed upon a specified browser event to return the date/time stamp and session ID to the server. One exemplary event is when a page is rendered (e.g., the “onLoad” event supported by JavaScript). Other events might also be employed, such as document load or a default script execution.

As another alternative, a page ID may be generated and sent with the script in place of the date/time stamp. The page ID is then associated with a date/time and stored at the server (e.g., in a look up table). When the page ID is subsequently returned, the associated date/time is retrieved (e.g., via a table lookup function) and used to compute the page render time.

The server 104 also implements a render time measurement module 136 that uses the date/time stamp returned from the client (or retrieved upon return of the page ID) to measure the time lapse between the time a user activates a hyperlink for a hypertext document (e.g., a web page) and the time the document is rendered at the user computer. More specifically, the measurement module 136 computes a difference between the returned stamp and the current time to produce a client page render time.

The measurement module 136 logs the results in a render time log 138. Each record in the log 138 might include such information as a client ID, the session ID, and a page render time. The measurement module 136, or other software, may then be used to statistically analyze the results kept in the render time log 138 to derive an average time to render client pages. While the average render time for all pages delivered is useful, it may not be a fair measure of the average user experience. A single user with a large number of page hits that has either a very fast or very slow average page render time would skew the average. For example, consider the case where there are 200 hits and 10 separate user sessions. If one user accounted for 100 of those hits with an average of 5 seconds to render a page and the remaining 9 users averaged 10 seconds to render a page, the overall average render time would be seven seconds (i.e., (100×5+9×100 )/200=7). In this example, the fast user skewed the average down. The distribution may not be Gaussian.

Another approach is to look at the distribution of the average render time per unique user session. Unique users are identified via the unique session ID and grouped accordingly. Continuing the previous example, the average session render times would be 9.5 seconds (i.e., (5+9×10)/10=9.5). This gives a more accurate number for the average session. In addition, it also guarantees that the resulting distribution is Gaussian, due to the central limit theory.

The render time measurement module 136 is also configured to compute an average page render time on a per user basis. The module 136 tallies the page render times collected in the log 138 that have the same session ID. An average render time per user can then be derived by dividing the total time for a given session ID by the number of entries associated with the session ID.

The server software 130, date/time stamp module 132, a session ID module 134, and render time measurement module 136 are illustrated as being integrated into the operating system 124 as one suitable implementation. However, in other implementations, one or more of these software programs may be implemented separately from the operating system. Moreover, it is noted that these components may be implemented on more than one server. For example, the server software 130 and the date/time stamp module 132 may be implemented on separate servers so that the server that generates the page is not the same server that time stamps the outgoing page.

The client-server system 100 implements an architecture for remotely monitoring how fast a page is rendered on the client computer from the time the user first requests the page. The monitoring generally occurs at the server computer 104, remotely from the client computer 102. The client computer 102 requires no additional software, other than a conventional browser or other type of program that is capable of rendering hypertext documents.

Generally, when the server 104 receives a request from the client, it locates or generates the appropriate page and attaches a script with the current date/time stamp (or other value). The stamped page is returned to the client and rendered. Upon complete rendering, the script is executed at the client to return the date/time stamp to the server. The server measures the time lapse between the returned date/time stamp and the current date/time value to derive a close approximation of client page render time. Even though this effectively measures the round trip time from server to client to server, the server assumes that the time required to submit requests from the client to the server is approximately constant (within a given time frame) and hence, the last client-to-server request to return the date/time stamp is approximately equal to the initial client-to-server request for the page. Thus, the round trip time from server to client to server approximates the total time from client to server to client.

Remote Monitoring Process

To illustrate the monitoring process in more detail, FIG. 2 is provided to show relevant components of the client-server system 100 that form a remote monitoring architecture 200 for remotely monitoring client page render times. The architecture 200 includes the client-side browser 116 and the server-side server software 130, date/time stamp module 132, session ID module 134, render time measurement module 136, and render time log 138.

For purposes of continuing discussion, the client-server system 100 is described in the context of the Internet in which the server is configured as a website host computer that serves web pages to requesting clients for rendering on the clients' web browser that supports JavaScript or ECMA-script scripting. In this context, the client submits HTTP requests for web pages and the server returns the requested pages.

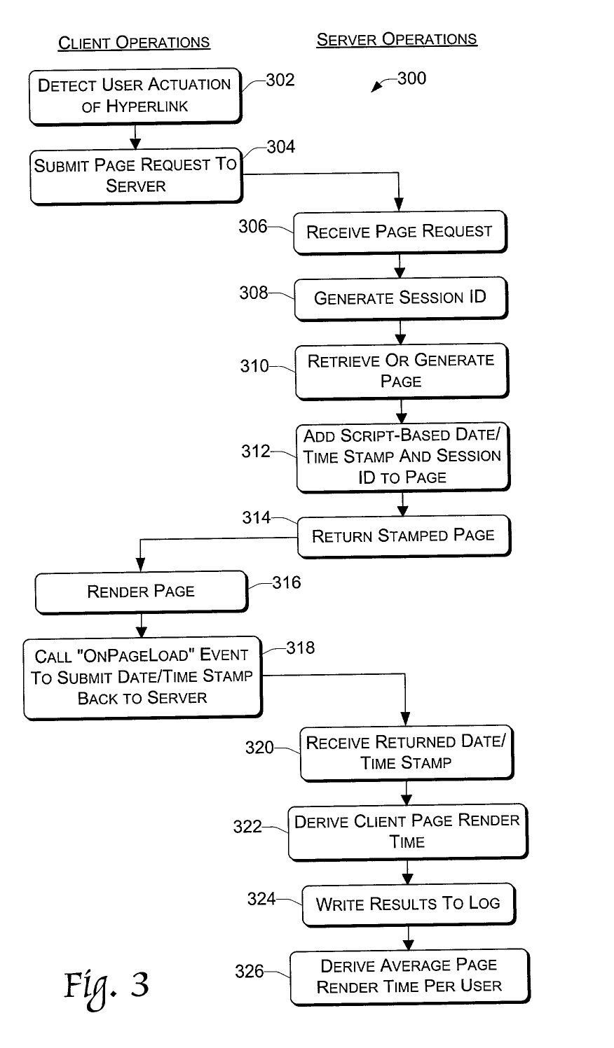

FIG. 3 illustrates a process 300 for remotely monitoring client page render times. The process is implemented by architecture 200 as computer-executable instructions stored on the client and server such that, when these instructions are executed, they perform the operations illustrated as individual blocks. The operations are grouped beneath headings “Client Operations” and “Server Operations” to indicate generally where the operations are performed. The process will be described with reference to the architecture 200 of FIG. 2 and the system 100 of FIG. 1.

Initially, at the client 102, the browser 116 renders a first web page 202 that has a hyperlink 204 to a second page. Suppose that the user actuates the hyperlink 204 (e.g., by moving a mouse pointer to the link and clicking the left mouse button). The client browser 116 detects the user actuation (block 302 in FIG. 3) and submits an HTTP request 206 to the server 104 (block 304 in FIG. 3).

The server receives the request and passes it to the server software 130 for handling (block 306). The session ID module 134 generates a unique session ID for the client-server session (block 308). The server software 130 retrieves a static page from storage, or dynamically generates a page, to be returned to the client in response to the request (block 310). A date/time stamp generated by the date/time stamp module 132, together with the associated session ID, are added to the page before the page is returned to the client (block 312). Along with the date/time stamp and session ID, a script is also added to the page. The script is an executable program that, when executed at the client, will send the date/time stamp and session ID back to the server. The server 104 returns a reply 208 consisting of the page 2, the date/time stamp, the session ID, and the script (block 314). As noted above, the server may return a page ID instead of the date/time stamp, which is stored locally in correlation with the page ID.

Back at the client 102, the browser 116 renders the second page 210 for the user to view (block 316 in FIG. 3). The date/time script 212 and the session ID 214 are included with the page, but hidden from the user. Upon completion of the rendering (e.g., onLoad event) or some other event (e.g., page load), the script 212 is executed. In one implementation, the script is executed by calling a function named “OnPageLoad” when the page is rendered (e.g., onLoad event). The script function “OnPageLoad” extracts the original date/time stamp (or page ID) and session ID and return it in the form of an HTTP request 216 to the server 104 (block 318).

The server 104 receives the date/time stamp and session ID and passes them to the render time measurement module 136 (block 320). As an alternative, the session ID may originally be stored at the server and not sent to the client with the date/time stamp. In this case, the server looks up the session ID associated with the returned date/time stamp. Furthermore, where the page ID is sent in place of the date/time stamp, the page ID is received and used to lookup the associated date/time stamp stored at the server.

The render time measurer 136 compares the returned date/time stamp with a current date/time value and computes the difference (block 322). The resulting difference is the actual round trip time from the moment the page is served to the client to the time that the date/time stamp is returned to the server:

$$\begin{matrix}Δ {T}_{Server \text{-} Client \text{-} Server} = Current Date \text{/} Time - Returned Date \text{/} Time \\ = Δ {T}_{leg208} + Δ {T}_{render} + Δ {T}_{leg216}\end{matrix}$$

where ΔT_{leg 208} represents the time period from the moment the page is stamped to the instance the page is received at the client, ΔT_{render} represents the time period to render the page on the client and execute the script, and ΔT_{leg 216} represents the time period from the moment the script initiates the request returning the date/time stamp to the moment the measurement module 136 computes the time difference.

The goal, however, is to compute a client page render time as the time period from the instance the user actuates the link to the moment the page is finished being rendered on the client computer. The client page render time is represented as:

ΔT_{Client-Server-Client}=ΔT_{leg 206}+ΔT_{leg 208}+ΔT_{render}

where ΔT_{leg 206} represents the time period between the user's initial actuation of the link 204 and when the server attaches the date/time stamp to the served page. As a result, the computed difference is not a precise measurement of the client page render time.

The measurement module 136 makes the assumption, however, that the time period between when the user initially actuated the link 204 and when the server attaches the date/time stamp to the served page (i.e., ΔT_{leg 206} for client-to-server leg 206 in FIG. 2) is approximately equal to the time period between when the script is executed to submit the date/time stamp and when the date/time stamp is compared to the current date/time value (i.e., ΔT_{leg 216} for client-to-server leg 216 in FIG. 2). This assumption is represented as follows:

Assumption:ΔT_{leg 206}≅ΔT_{leg 216}

This assumption is valid since the first request and the return of the date/time stamp are expected to occur relatively close in time and hence, the network conditions (such as congestion, server load, etc.) are approximately constant within the given time frame. Given this assumption, the computed difference effectively represents (or at least very closely approximates) the client page render time taken from the instance that the user activates a link to the instance that the requested page is rendered, as follows:

Client Page Render Time≅ΔT_{leg 216}+ΔT_{leg 208}+ΔT_{render}

The computed page render time is placed in the log 138 and associated with the session ID (block 324). Statistical analysis may then be applied to the log to determine an average speed per page. This average provides a useful metric to gauge users' perception of web performance. Over time, analysis of the historical trend will provide insight as to whether improvements to page design and network/computing resources translate into a more enhanced user experience.

In addition to measuring the average speed per page, the measurement module 136 can further use the logged render times for a given session ID to compute an average render time per user (block 326). More particularly, the measurement module 136 computes an average by summing the render times recorded in log 138 for a common session ID. This total is then divided by the number of entries with the common session ID to produce an average render time per use, as follows:

Average Page Render Time Per User=(CPRT_{ID1}(1)+CPRT_{ID1}(2)+CPRT_{ID1}(3)+ . . . +CPRT_{ID1}(j))/j

Conclusion

The present invention is advantageous over prior art solutions in that it provides an effective metric to gauge how quickly pages are being served and rendered to the user. Prior to this invention, attempts to measure this type of performance focused on the size of the page and estimated the cycle time based on page size. With this solution, there is now an objective measure of “time to display” for pages that captures the user experience when interacting with a particular website. Moreover, the “time to display” can be monitored on a per user basis, in addition to an average speed per page.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
receiving, from a client, a request for a document;
assigning a session ID to uniquely identify a session established with the client;
generating a time stamp;
associating the time stamp with the session ID;
serving the document along with a time stamp and an executable script to the client, the executable script being configured to return the time stamp when the document is rendered on the client;
receiving the time stamp from the client;
deriving a document render time from the time stamp, the document render time being indicative of a time period from when the request for the document is generated at the client to when the document is rendered at the client;
logging the document render time in association with the session ID that is associated with the time stamp from which the document render time is associated; and
determining an average render time per user as a function of one or more logged document render times for a common session ID.

2. A method as recited in claim 1, wherein the document comprises a web page.

3. A method as recited in claim 1, wherein the deriving comprises computing a time period from the time stamp and a current time, the time period representing the document render time.

4. A method as recited in claim 1, wherein multiple document render times for a given session ID are logged, and the determining further comprises computing an average render time per user by averaging the document render times for the common session ID.

5. A method as recited in claim 1, further comprising sending the session ID together with the time stamp to the client and receiving the session ID and the time stamp back from the client upon execution of the scrip.

6. A method as recited in claim 1, further comprising logging the average render time.

7. A method, comprising:
receiving multiple requests for information from a client during a session;
sending responses to the client, each response containing a value and an executable program, the executable program being configured to return the value when the information is presented on the client;
receiving the values from the client in response to execution of the executable program contained with each said response; and
ascertaining a metric representative of an average time to display requested information as a function of the values received for the session.

8. A method as recited in claim 7, wherein the value is derived from a monotonically increasing source and the ascertaining comprises:
comparing the value with a current value from the monotonically increasing source;
deriving a time to display result as a function of the value and the current value;
collecting multiple time to display results; and
deriving the average time to display as a function of the time to display results.

9. A method as recited in claim 7, wherein the value is a time stamp and the ascertaining comprises:
comparing the time stamp with a current time;
deriving a time to display result as a difference between the time stamp and the current time;
collecting multiple time to display results; and
deriving the average time to display as a function of the time to display results.

10. A method as recited in claim 7, further comprising logging the average time to display.

11. A method, comprising:
receiving multiple requests for information from multiple clients during various user sessions;
sending responses to the clients, each response containing a value and an executable program, the executable program being configured to return the value when the information is presented on the client;
receiving the values from the clients in response to execution of the executable program contained with each said response; and
ascertaining an average render time per unique user session as a function of the values received for the clients.

12. A server system, comprising:
a server to receive one or more requests for renderable documents from a client during a session, the server being configured to serve the documents in response to the requests, each served document being accompanied by a script and a time value;
individual scripts being configured to execute in response to their corresponding documents being rendered on the client such that when executed, the individual scripts return the time value to the server; and
a time-to-render monitor to determine an average render time based on returned time values for the session.

13. A server system as recited in claim 12, wherein the document comprises a web page.

14. A server system as recited in claim 12, wherein the time-to-render monitor approximates a render time for each returned time value by calculating a difference between the time stamp and a current time.

15. A server system as recited in claim 14, further comprising a log to store the approximated render times, the average render time being derived from an average of the approximated render times for a common session ID.

16. A server system as recited in claim 12, wherein each served document is further accompanied by the session ID and the script, when executed, returns the session ID along with the time value.

17. An architecture, comprising:
a server module resident at a first computer to serve one or more documents from the first computer to a second computer during a session, each document being accompanied by a time stamp and an executable script that executes when the document is rendered at the second computer to return the time stamp to the first computer; and
a render time measurement module resident at the first computer to receive the time stamps returned from the second computer and to derive an average document render time from the time stamps received for the session.

18. An architecture as recited in claim 17, wherein the document comprises a document written in a markup language.

19. An architecture as recited in claim 17, wherein the render time measurement module approximates the document render time by calculating a difference between the time stamp and a current time.

20. An architecture as recited in claim 17, wherein the render time measurement module derives a document render time from each time stamp, the document render time being representative of a time period from when a request for the document is first generated at the second computer to when the document is rendered at the second computer, the.

21. An architecture as recited in claim 17, further comprising a browser resident at the second computer to render the document.

22. A server computer comprising the architecture as recited in claim 17.

23. Computer-readable media having computer-executable instructions that, when executed by one or more processing units, direct one or more computing devices to:
serve a renderable document together with a time stamp and an executable program from a server to a client, the time stamp being associated with a session ID identifying a session with the client;
execute, upon rendering of the document at the client, the executable program at the client to return the time stamp to the server; and
derive a document render time from the time stamp, the document render time being indicative of a time period from when the request for the document is generated at the client to when the document is rendered at the client; and
determine an average document render time per user as a function of multiple document render times derived over time for a common session ID.

24. Computer-readable media as recited in claim 23, further comprising computer-executable instructions that, when executed by one or more processing units, direct one or more computing devices to compute the document render time from a function of the time stamp and a current time.

25. Computer-readable media as recited in claim 23, further comprising computer-executable instructions that, when executed by one or more processing units, direct one or more computing devices to serve the session ID along with the time stamp and to return the session ID with the time stamp back to the server.
